(19) United States
(12) Patent Application Publication
(10) Pub. No.: US 2003/0225783 A1
(43) Pub. Date: Dec. 4, 2003

(54) Task object correlation method

(76) Inventors: Han-Chao Lee, Taipei (TW); Yen-Liang Lu, WhaLieng (TW); Tsung-Wei Tu, Tainan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/217,828

(22) Filed: Aug. 12, 2002

(30) Foreign Application Priority Data
May 28, 2002 (CN) 91111350

(51) Int. Cl. G06F 7/00

(52) U.S. Cl. 707/103 R

(57) ABSTRACT

A task object correlation method. First, at least one sub-task object corresponding to a task object is built. The sub-task object has an attribute and a correlation between the task object and the sub-task object is built automatically. Then, the task object and the sub-task object are stored into an object correlation database. When users need to track sub-task objects, a task object is selected and a classification is designated. Then, at least one sub-task object whose attribute conforms to the designated classification is retrieved from the object correlation database according to the task object and the designated classification.

### BACKGROUND OF THE INVENTION

1. Field of the Invention

The present invention relates to a task object correlation method, and particularly to a method that builds correlation between task objects automatically and tracks task objects according to the correlation.

2. Description of the Related Art

In recent workflow systems, work lists show the work items for which users are responsible. Users can handle only one work item at a time when a user logs into the work interface of the workflow system. That is there are no correlation between work items in current systems.

However, a task is always composed of several work items, and each employs different applications. In current practice, users have to choose the appropriate application for each work item. After all of the work items are carried out, the results are compiled to finish the task.

In enterprise, a general user cannot normally access an overall view of tasks and workflow since the processes of work allotment, execution and inquiry cannot be recorded within the authority of the user. Further, the results are scattered due to the lack of efficient integration and management mechanism.

### SUMMARY OF THE INVENTION

It is therefore an object of the present invention to provide a method that builds correlation between task objects automatically and tracks task objects according thereto. In the present invention, task objects maybe the work item, responsible party, time and/or location and related applications. That is, personnel, tasks, times, and locations can be regarded as task objects, and correlation is developed between them.

To achieve the above object, a task object correlation method according to the embodiment of the present invention is provided. First, at least one sub-task object corresponding to a task object is built. The sub-task object has an attribute. At the same time, a correlation between the task object and the sub-task object is built, and the task object and the sub-task object are stored into an object correlation database.

Then, a task object is selected and a classification corresponding to the attribute of a sub-task object is designated. Thereafter, at least one sub-task object whose attribute conforms to the designated classification is retrieved from the object correlation database according to the task object and the designated classification. The sub-task object is displayed.

According to the embodiment of the present invention, at least one detailed catalogue object corresponding to the sub-task object is further built. The detailed catalogue object has an attribute. At the same time, a correlation between the sub-task object and the detailed catalogue object is built, and the sub-task object and the detailed catalogue object are stored into the object correlation database.

Then, a sub-task object is selected and a classification corresponding to the attribute of a detailed catalogue object is designated. Thereafter, at least one detailed catalogue object whose attribute conforms to the designated classification is retrieved from the object correlation database according to the sub-task object and the designated classification.

According to the embodiment of the present invention, a display interface is provided to display the task object. Further, the sub-task object is displayed when the sub-task object is retrieved from the object correlation database according to the task object and the designated classification. Furthermore, the detailed catalogue object is displayed when the detailed catalogue object is retrieved from the object correlation database according to the sub-task object and the designated classification.

### BRIEF DESCRIPTION OF THE DRAWINGS

The aforementioned objects, features, and advantages of this invention will become apparent by referring to the following detailed description of the preferred embodiment with reference to the accompanying drawings, wherein:

FIG. 1 is a flowchart illustrating the operation of the task object correlation method according to the embodiment of the present invention;

FIG. 2 is a schematic diagram illustrating the full view of a task;

FIG. 3 shows the working model of the example in FIG. 2; and

FIGS. 4a to 4c shows partial views of the task in FIG. 2 belonging to different users.

### DETAILED DESCRIPTION OF THE INVENTION

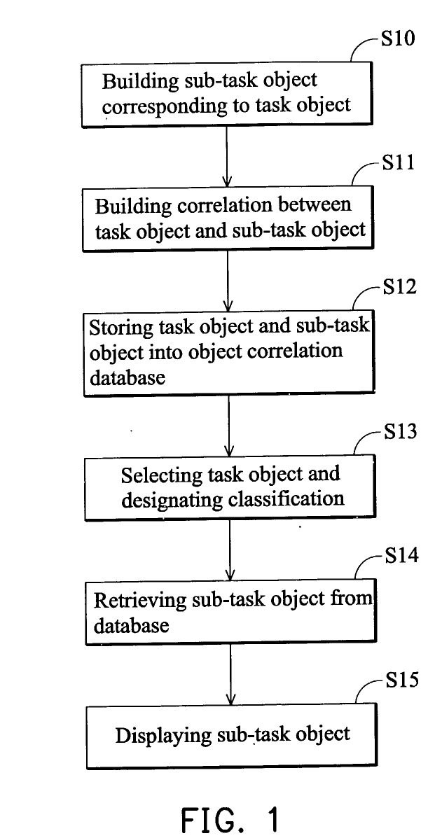

FIG. 1 is a flowchart illustrating the operation of the task object correlation method according to the embodiment of the present invention. In the present invention, task objects may be the work item, responsible party, time and/or location and related applications. That is, personnel, tasks, times, and locations can be regarded as task objects.

First, in step S10, at least one sub-task object corresponding to a task object is built. The sub-task object has an attribute. If a plurality of sub-task objects is built, each of the sub-task objects may have its own attribute. At the same time, in step S11, a correlation between the task object and the sub-task object is built automatically, and in step S12, the task object and the sub-task object are stored into an object correlation database.

For example, a main task and a work item corresponding to the main task and the agent of the work item are entered into the workflow system by a user. The main task, work item, and agent are regarded as task objects and stored into the object correlation database. At the same time, a correlation between the main task, the work item, and the agent is built.

When users need to track sub-task objects, in step S13, a task object is selected and a classification corresponding to the attribute of a sub-task object is designated. Thereafter, in step S14, at least one sub-task object whose attribute conforms to the designated classification is retrieved from the object correlation database according to the task object and the designated classification. Finally, in step S15, the sub-task object retrieved from the object correlation database is displayed.

Note that a display interface is provided to display the task object and the sub-task object when the sub-task object is retrieved from the object correlation database in step S15.

It should be noted that the task objects might be the work item, responsible party, time and/or location and related applications. That is, personnel, tasks, times, and locations can be regarded as task objects, and correlation is developed between them.

Further, at least one detailed catalogue object corresponding to the sub-task object may be built. The detailed catalogue object has an attribute. At the same time, a correlation between the sub-task object and the detailed catalogue object is built, and the sub-task object and the detailed catalogue object are stored into the object correlation database.

Similarly, when users need to track detailed catalogue objects, a sub-task object is selected and a classification corresponding to the attribute of a detailed catalogue object is designated. Thereafter, at least one detailed catalogue object whose attribute conforms to the designated classification is retrieved from the object correlation database according to the sub-task object and the designated classification, and the retrieved detailed catalogue object can be displayed in the display interface. Note that detailed objects can be built for the detailed catalogue object in the same manner.

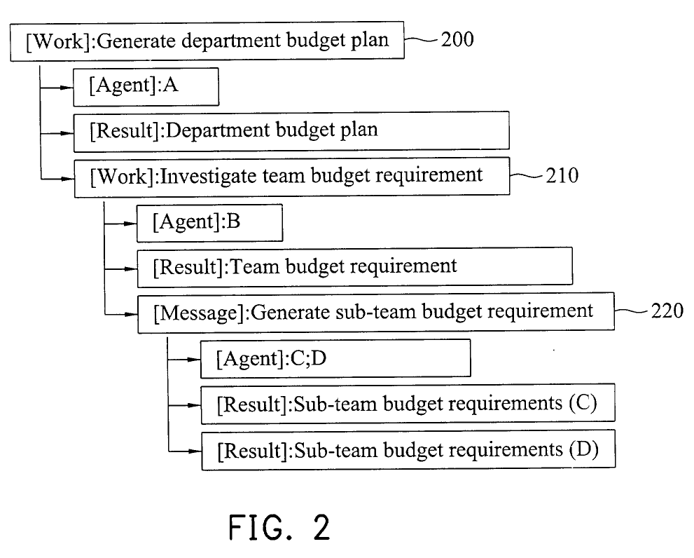

FIG. 2 is a schematic diagram illustrating the full view of a task. In this example, A is the administrator of the main task (task object) “Generate department budget plan” 200, and a department budget plan is requested. Since A is the director of the department, A builds a work item (sub-task object) “Investigate team budget requirement” 210, and assigns to team leader B. In this work item, a team budget requirement is requested.

Since B manages two sub-teams, B builds a work message (detailed catalogue object) “Generate sub-team budget requirement” 220, and assigns it to sub-team leaders C and D. In this work message, two sub-team budget requirements (C and D) are requested to provide. Note that the connections between the blocks in FIG. 2 represent the correlation between the task objects.

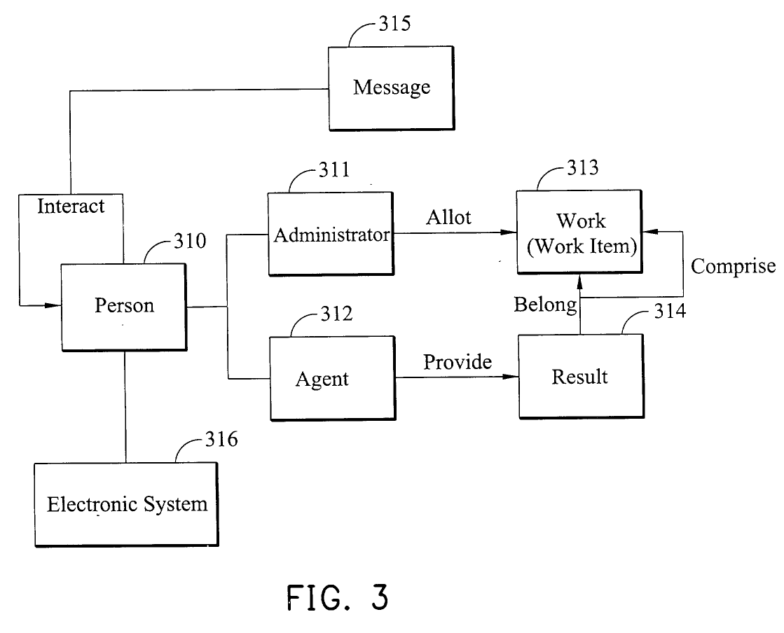

FIG. 3 shows the working model of the example in FIG. 2. For A and B, A is the administrator 311 and B is the agent 312; for person B, C and D, B is the administrator 311 and C and D is the agent 312. The result 314 provided by the agent 312 belongs to the work or work item 313 allotted by the administrator 311. In this case, all personnel, tasks, times, and locations can be regarded as task objects, and they can interact according to correlation through message (message system) 315 and electronic operating system 316.

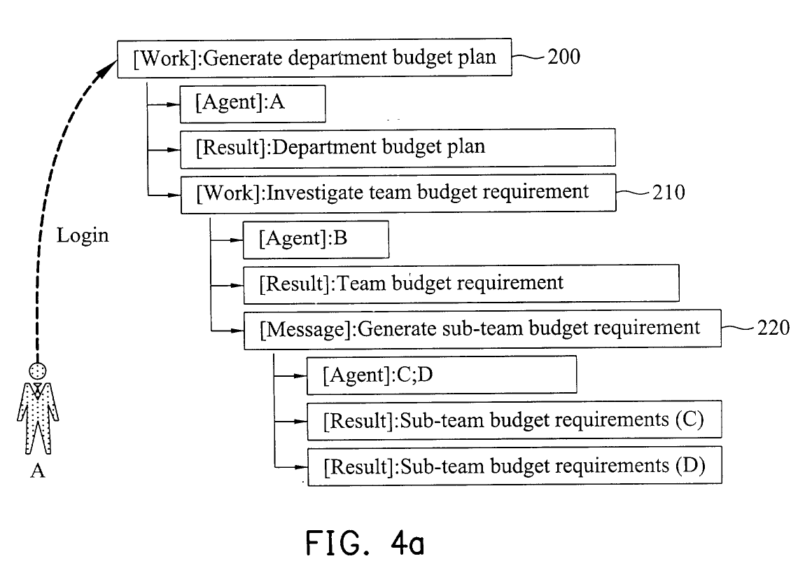

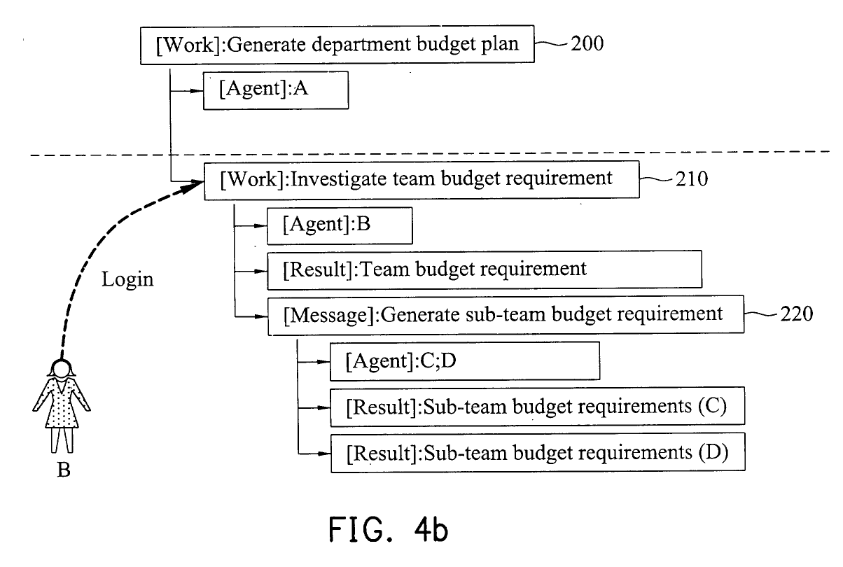

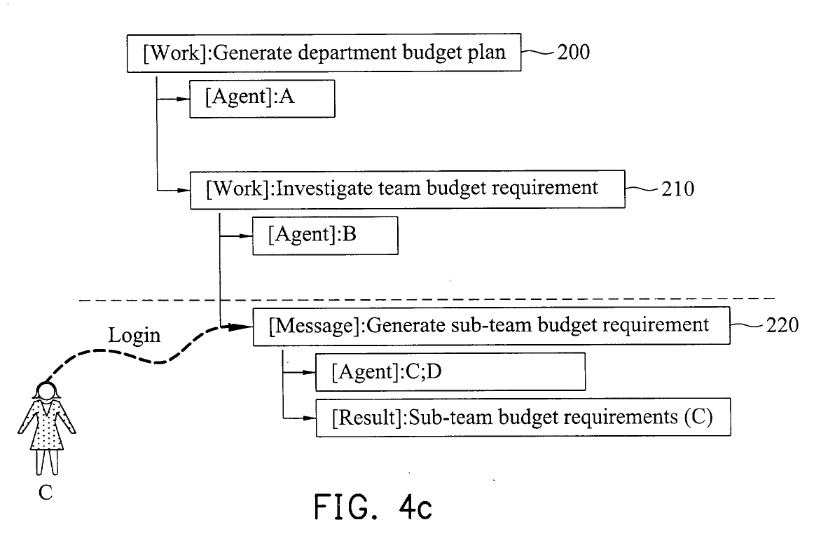

Since each user has different authority, the views of the whole task may be different when integrated with authorization management. FIGS. 4a to 4c shows partial views of the tasks in FIG. 2 belonging to person A, B and C.

As shown in FIG. 4a, since A is the administrator of the task, the full view of the task can be seen when A logs into the workflow system. When B logs into the workflow system, all details of the work item 210 built by B and the work 200 and administrator of the work (person A) can be seen, as shown in FIG. 4b. When C logs into the workflow system, details of the work 220 allotted by person B, the work 200 and administrator of the work (person A) and the work item 210 and administrator of the work item (person B) can be seen, as shown in FIG. 4c. D is similar to C except its own result.

In addition, workflow systems always operate within allotted time controls. Each task object may be assigned a date tag to remind the agent to finish his allotted job within the date.

As a result, the task object correlation method according to the present invention can build correlation between task objects automatically and track task objects according to the correlation.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A task object correlation method, comprising the steps of:
building at least one sub-task object corresponding to a task object, wherein the sub-task object has an attribute;
building a correlation between the task object and the sub-task object automatically;
storing the task object and the sub-task object into an object correlation database;
selecting a task object and designating a classification corresponding to the attribute of a sub-task object; and
retrieving at least one sub-task object whose attribute conforms to the designated classification from the object correlation database according to the task object and the designated classification.

2. The method as claimed in claim 1 further comprising the step of:
building at least one detailed catalogue object corresponding to the sub-task object, wherein the detailed catalogue object has an attribute;
building a correlation between the sub-task object and the detailed catalogue object; and
storing the sub-task object and the detailed catalogue object into the object correlation database.

3. The method as claimed in claim 2 further comprising the step of:
selecting a sub-task object and designating a classification corresponding to the attribute of a detailed catalogue object; and
retrieving at least one detailed catalogue object whose attribute conforms to the designated classification from the object correlation database according to the sub-task object and the designated classification.

4. The method as claimed in claim 1 further displaying the task object in a display interface.

5. The method as claimed in claim 4 further displaying the sub-task object in the display interface when the sub-task object is retrieved from the object correlation database.

6. The method as claimed in claim 3 further displaying the task object and the sub-task object in a display interface.

7. The method as claimed in claim 6 further displaying the detailed catalogue object in the display interface when the detailed catalogue object is retrieved from the object correlation database.
